(19) United States
(12) Patent Application Publication
(10) Pub. No.: US 2021/0379482 A1
(43) Pub. Date: Dec. 9, 2021

(54) GAMIFIED SOCIAL MEDIA

(71) Applicant: Shadman Sakib, Walnut, CA (US)

(72) Inventor: Shadman Sakib, Walnut, CA (US)

(21) Appl. No.: 16/894,765

(22) Filed: Jun. 6, 2020

(51) Int. Cl. A63F 9/18; A63F 13/35

(52) U.S. Cl. CPC A63F 9/183; A63F 2009/186; A63F 13/35

(57) ABSTRACT

A gamified social media platform is provided to encourage interaction and communication among its users and make it more exciting. The platform of present invention allows its user to communicate through a server of the platform by accessing the server using any smart user device. The present platform allows author user to upload a thought, image or video over the server which gets distributed among the author user's friends and followers without disclosing the detail of the author user and the recipient user only can comment after guessing the correct author user as a guessing game.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

### Field of the Invention

The present disclosure relates generally to a social media platform. More so, the present disclosure relates to a gamified social media platform.

### Description of the Related Art

There are several social media platforms available currently that allow users to communicate among themselves. Many of these platforms also allow users to play online multiplayer games amongst themselves. However, none of the existing social media platforms uses games to encourage interaction and communication among its users, making communication bland and unexciting over a period of time.

Therefore, there is a need of a social media platform that gamifies communication among its users.

### SUMMARY OF THE INVENTION

A primary object of the disclosure is to provide a social media platform.

Another object of the present disclosure is to provide a social media platform that allows gamification of communication between its users.

### BRIEF DESCRIPTION OF THE DRAWINGS

Having thus described the disclosure in general terms, reference will now be made to the accompanying figures, wherein:

FIG. 1 illustrates a user network of a social media platform that allows its users to communicate to each other through a server,

FIG. 2 illustrates a method of playing a guessing game on a social media platform,

FIG. 3 illustrates a method of assigning temporary details to an author user,

FIG. 4 illustrates a screenshot of a recipient user when a post from an author in an invisible state is received,

FIG. 5 illustrates a screenshot of a recipient user who has tapped a guess button to play a guessing game, and

FIG. 6 illustrates a screenshot of a recipient user who has successfully guessed an author name associated with a post.

It should be noted that the accompanying figures are intended to present illustrations of exemplary embodiments of the present disclosure. This figure is not intended to limit the scope of the present disclosure. It should also be noted that accompanying figures are not necessarily drawn to scale.

### DETAILED DESCRIPTION OF THE INVENTION

Reference will now be made in detail to selected embodiments of the present disclosure in conjunction with accompanying figures. The embodiments described herein are not intended to limit the scope of the disclosure, and the present disclosure should not be construed as limited to the embodiments described. This disclosure may be embodied in different forms without departing from the scope and spirit of the disclosure. It should be understood that the accompanying figures are intended and provided to illustrate embodiments of the disclosure described below and are not necessarily drawn to scale. In the drawing, like numbers refer to like elements throughout, and thicknesses and dimensions of some components may be exaggerated for providing better clarity and ease of understanding.

It should be noted that the terms “first”, “second”, and the like, herein do not denote any order, ranking, quantity, or importance, but rather are used to distinguish one element from another. Further, the terms “a” and “an” herein do not denote a limitation of quantity, but rather denote the presence of at least one of the referenced item.

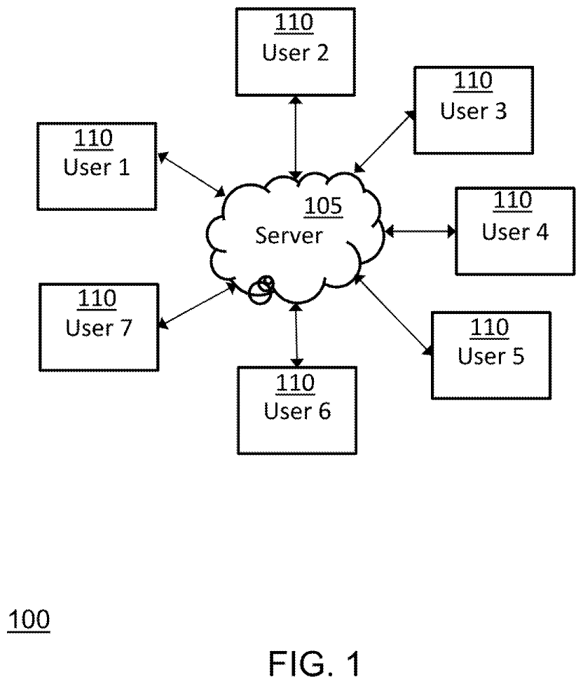

FIG. 1 illustrates a user network 100 of a social media platform that allows its users 110 to communicate to each other through a server 105. The users 110 can use various devices such as a mobile phone, a tablet, a computer, etc. to access the social media platform. For example, a user 1 can send a message a user 2 through the server 105, and the user 2 can respond back to the user 1 through the server 105. In another example, the user 1 can send a message to multiple users such as user 2, 3 and 4. Each of the users 2, 3 or 4 can respond back to the user 1. In the user network 100, each user has two or more friends and followers.

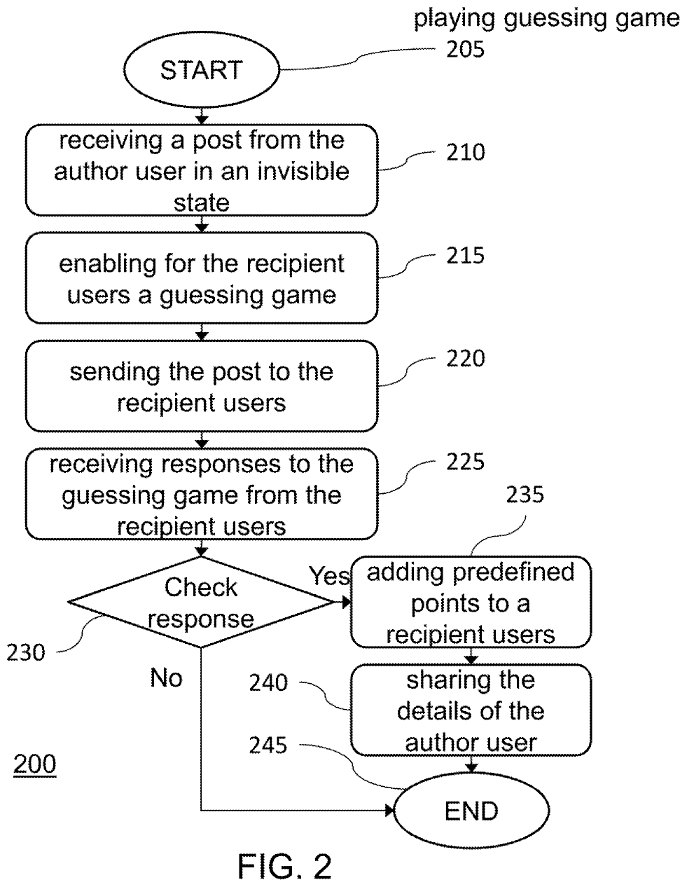

FIG. 2 illustrates a method 200 of playing a guessing game on a social media platform. The method 200 of playing the guessing game initiates at step 205. A user can send a post to his friends and followers. Such a user is referred to as an author user. The post is can be a thought, a message or a video. At step 210, the server 105 receives a post and a distribution list from the author user. The author user can select from his friends and followers users to whom he want to share his post. The selected recipient users are in the distribution list. The server then checks if the author user is in a visible state or an invisible state. In the invisible state the author user's details are hidden. A guessing game may be played only when the author user is in the invisible state where temporary user details are provided for the author user. Alternatively, if the author user is in a visible state the guessing game is not enabled for the recipient users. When the author user is in the visible state, the recipient users can comment on the post without paying the guessing game if the post is a message or a video. The comment is sent to the author user. However, without playing the guessing game, the details of the author user remains hidden to the recipient users. If the post is a thought, the recipient users can't comment without playing the guessing game and correctly guessing author details.

After checking that the author user is in the invisible state, the server 105, at step 215 enables the guessing game for the recipient users, where objective is to guess the correct author of the post from three options presented to them by the server 105. Each of the three options have equal probability of being correct. The post is sent to the recipient users by the author user through the server 105, at step 220. The recipient users have two options now either to reply to the post or to play the guessing game. The recipient users, who choose to play the guessing game, select one of the three options presented to them and their response is received at the server 105 at step 225. The responses are then checked at step 230. The recipient users, who could not guess the correct author of the post, are not able to see the actual details of the author user and the method 200 ends at step 245. The recipient users, who are able to the guess correct author of the post, earn a predefined number of points at step 235 and the author user details are shared to them at step 240, Those recipient users are then able to see details and identity of the author user after they correctly guess the author of the post from the three options presented to them. Also, the recipient users are enabled to comment on a ‘thought’ post of the author user after correctly guessing the author of the post. The method 200 then ends at step 245.

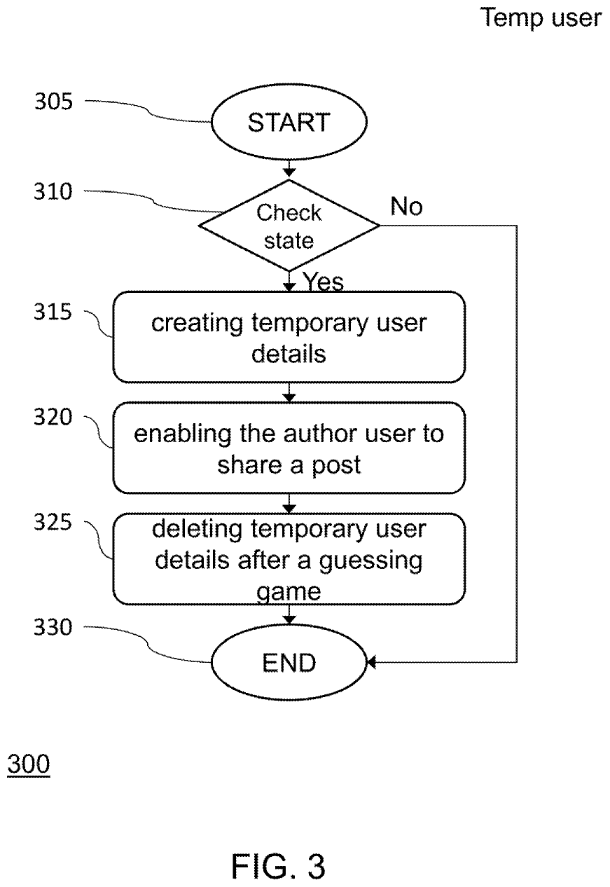

FIG. 3 illustrates a method 300 of assigning temporary details to the author user. The method initiates at step 305. The server 105 checks weather the author user is in the invisible state at step 310. If the author user is not in the invisible state then the method 300 ends at step 330. If the author user is in the invisible state then temporary user details are created for the author user, while the original user details are hidden form the recipient users, at step 315, The author user, with the temporary user details, can share a post with the recipient users at step 320. For example, the name of the author user remains invisible from the recipient users when they receive a post of the author user. Instead, the recipient users will see a post from a friend without knowing which of their friend has sent the post. When the recipient users have played the guessing game for the post, temporary user details are deleted at step 325. The method 300 then end at step 330.

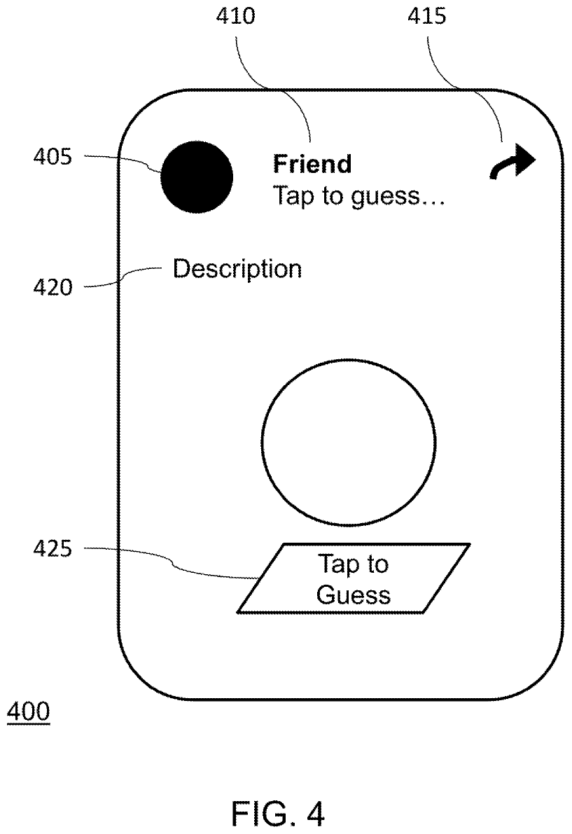

FIG. 4 illustrates a screenshot 400 of a recipient user when a post from an author in an invisible state is received. The screenshot 400 shows an image placeholder 405 and a status box 410 of the author user that shows temporary details of the author user. For example, a user named John selects the invisible state, the server 105 replaces his name and image with a temporary name such as ‘friend’ and a predefined image to hide author user's identity from the recipient users. The recipient users have an option to reply to the post by clicking a reply button 415. The reply option is enabled only if the post is a message or a video. In case, the author user has posted a thought, then the reply option remain disabled for the recipient users. The recipient users can tap the status box 410 or a guess button 430 to play the guessing game.

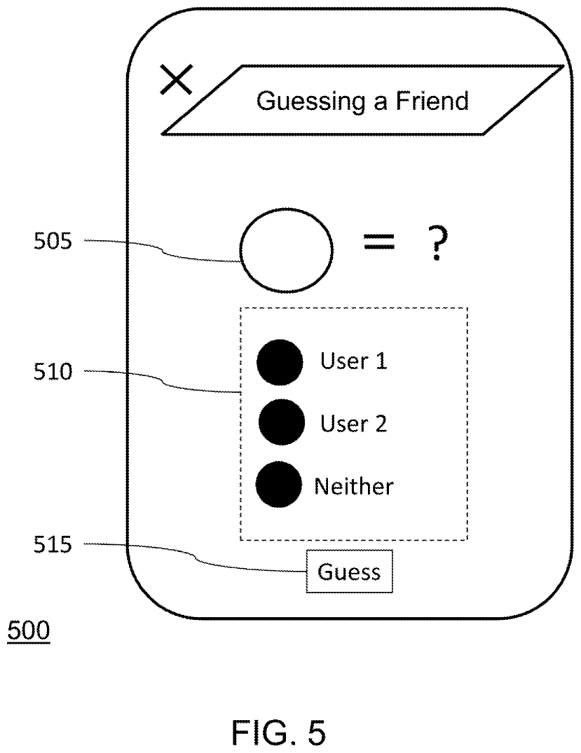

FIG. 5 illustrates a screenshot 500 of a recipient user who has tapped the guess button 425 to play a guessing game. An image placeholder 505 may show temporary details of an author user. Options 510 show three answers to the guessing game for the post posted by the author user. A recipient user can select one of the options namely ‘User 1, ‘User 2 and ‘Neither’. For example, if the recipient user selects ‘User 1 and the auther-user of the post is ‘User 1, the recipient user would have guessed correctly winning points for the correct guess. The recipient user can guess an author user for a post only once.

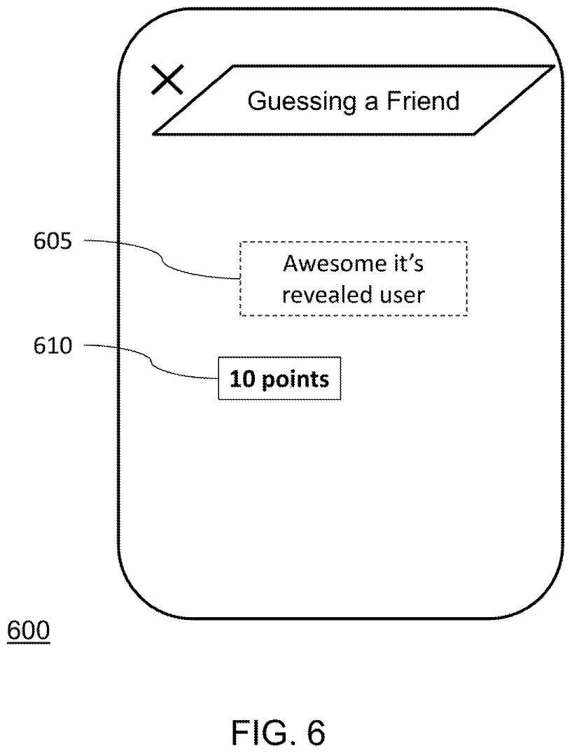

FIG. 6 illustrates a screenshot 600 of a recipient user who has successfully guessed an author name associated with a post. After successfully guessing the correct author name, author details are shown in the textbox 605 and addition of points is shown in a banner 610.

The present disclosure provide a social media platform that gamifies communication among its users keeping the communication exciting and alive for a long time. It also allows a partial anonymous communication where a sender user can be invisible while the recipient user's identity is disclosed.

What is claimed is:

1. A method of communication among a plurality of users, the method comprising:
communicating when an author user is in an invisible state, where details of the author user are hidden in the invisible state, where communicating further comprising:
receiving a post and a distribution list from the author user, where the author user has friends and followers, where the distribution list has names of recipient users selected from the friends and followers;
enabling for the recipient users a guessing game, where the guessing game has three options such that two options are friends of the recipient user, where objective of the guessing game is to guess correct author of the post;
sending the post to the recipient users;
receiving responses to the guessing game from the recipient users; and
adding predefined points to a recipient user when the recipient user select a correct option to the guessing game.

2. A method of claim 1, where the post is one of a thought, a message and a video.

3. A method of claim 1, where each user has two or more friends and followers.

4. A method of claim 1 further comprising communicating when an author user is not in an invisible state, where an option to play the guessing game is not enabled for the recipient users.

5. A method of claim 1, where communicating when an author user is in an invisible state further comprising enabling for the recipient users an option to comment on the post when the post is a video or a message without the recipient users having to play the guessing game such that the details of the author user remains hidden, where the comment is sent to the author user.

6. A method of claim 1, where communicating when an author user is in an invisible state further comprising:
sharing the details of the author user with a recipient user after the recipient user has guessed the correct option to the guessing game; and
enabling for the recipient user an option to comment on the post when the post is a thought after the recipient user has guessed the correct option to the guessing game, where the comment is sent to the author user.

7. A method of claim 1, where communicating when an author user is in an invisible state further comprising sharing the details of the author user with a recipient user after the recipient user has guessed the correct option to the guessing game.

8. A method of claim 1, where each of the three options of the guessing game has equal probability of being the correct option.

9. A method of claim 1, where communicating when an author user is in an invisible state further comprising creating a temporary user details for a user who has selected an invisible state.

10. A method of enabling communication for an author user in an invisible state, the method comprising:
creating temporary user details for the author user who has selected the invisible state, where details of the author user is hidden when the author user in the invisible state;
enabling the author user to share a post with recipient users with the temporary user details; and
deleting temporary user details after the recipient users have played a guessing game for the post.

11. A method of claim 10, where the guessing game has three options such that two options are friends of the recipient user where objective is to guess correct author of the post.

12. A method of claim 10, where the post is one of a thought, a message and a video.

13. A method of communication among a plurality of users, the method comprising:
communicating when an author user is in an invisible state, where communicating further comprising:
receiving a post and a distribution list from the author user, where the author user has friends and followers, where the distribution list has names of recipient users selected from the friends and followers;
hiding details of the author user;
enabling for the recipient users a guessing game, where the guessing game has three options such that two options are friends of the recipient user, where objective of the guessing game is to guess correct author of the post;
sending the post to the recipient users;
receiving responses to the guessing game from the recipient users; and
adding predefined points to recipient users that select a correct option to the guessing game;
communicating when an author user is not in an invisible state, where communicating further comprising:
not enabling an option to play the guessing game for the recipient users; and
enabling the recipient users to comment on the post of the author user.

14. A method of claim 13, where the post is one of a thought, a message and a video.

15. A method of claim 13, where each user has two or more friends and followers.

16. A method of claim 13, where communicating when an author user is in an invisible state further comprising enabling for the recipient users an option to comment on the post when the post is a video or a message without the recipient users having to play the guessing game such that the details of the author user remains hidden, where the comment is sent to the author user.

17. A method of claim 13, where communicating when an author user is in an invisible state further comprising:
sharing the details of the author user with a recipient user after the recipient user has guessed the correct option to the guessing game; and
enabling for the recipient user an option to comment on the post when the post is a thought after the recipient user has guessed the correct option to the guessing game, where the comment is sent to the author user.

18. A method of claim 13, where communicating when an author user is in an invisible state further comprising sharing the details of the author user with a recipient user after the recipient user has guessed the correct option to the guessing game.

19. A method of claim 13, where each of the three options of the guessing game has equal probability of being the correct option.

20. A method of claim 13, where communicating when an author user is in an invisible state further comprising creating a temporary user details for a user who has selected an invisible state.
